(19) United States
(12) Patent Application Publication
(10) Pub. No.: US 2025/0157100 A1
(43) Pub. Date: May 15, 2025

(54) FOUR-DIMENSIONAL MOTION ESTIMATION AND COMPENSATION BY USING FEATURE RECONSTRUCTION

(71) Applicant: CANON MEDICAL SYSTEMS CORPORATION, Tochigi (JP)

(72) Inventors: Qiulin TANG, Vernon Hills, IL (US); Jian ZHOU, Vernon Hills, IL (US); Liang CAI, Vernon Hills, IL (US); Chih-Chieh LIU, Vernon Hills, IL (US)

(73) Assignee: CANON MEDICAL SYSTEMS CORPORATION, Tochigi (JP)

(21) Appl. No.: 18/509,385

(22) Filed: Nov. 15, 2023

(51) Int. Cl. G06T 11/00; G06T 5/00; G06T 5/20; G06T 7/00; G06T 7/246

(52) U.S. Cl. CPC G06T 11/008; G06T 5/20; G06T 5/73; G06T 7/0012; G06T 7/248; G06T 11/006; G06T 2207/10081; G06T 2207/20081; G06T 2207/20084; G06T 2207/20201; G06T 2207/30048; G06T 2207/30061

(57) ABSTRACT

A medical image processing method includes obtaining a set of projection data acquired in a computed tomography (CT) scan of a three-dimensional region of an object to be examined; generating for each time point of a plurality of time points of the CT scan based on a part of the obtained set of projection data corresponding to the time point, a pair of feature maps for estimating motion at the time point so as to generate a plurality of pairs of feature maps, each feature map representing a feature of an image reconstructed from the part of the obtained set of projection data; estimating, based on the generated plurality of pairs of feature maps, a four-dimensional motion field; and reconstructing, based on the estimated four-dimensional motion field and the obtained set of projection data, a CT image of the object.

### FIELD

This disclosure relates to a system using feature maps to estimate motion in computed tomography (CT) scanned images and to compensate for the estimated motion in reconstruction of computed tomography (CT) scanned images, and more particularly to using image registration and deep learning (DL) networks to estimate the motion from the feature maps of the computed tomography (CT) scanned images.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Computed tomography (CT) systems and methods are widely used, particularly for medical imaging and diagnosis. CT systems generally create images of one or more sectional slices through a subject's body. A radiation source, such as an X-ray source, irradiates the body from one side. At least one detector on the opposite side of the body receives radiation transmitted through the body. The attenuation of the radiation that has passed through the body is measured by processing electrical signals received from the detector.

X-ray CT has found extensive clinical applications in cancer, heart, and brain imaging. As CT has been increasingly used for a variety of applications including, e.g., cancer screening and pediatric imaging, there has arisen a push to reduce the radiation dose of clinical CT scans to become as low as reasonably achievable. For low-dose CT, the image quality can be degraded by many factors, such as high quanta noise challenge scanning geometry (i.e., large cone angle, high helical pitch, truncation, etc.), and other non-ideal physical phenomenon (i.e., scatter, beam hardening, crosstalk, metal, etc.).

Eliminating motion artifacts is one of the most challenging issues in CT imaging. The artifacts result from two major types of motion: respiratory motion and cardiac motion. With non-cooperative patients or in an emergency case, breathing motion or motion of the skull can compromise image quality in CT scans. Motion artifacts of lung structures are unavoidable in routine practice of chest CT scans. The pulsatile motion of the heart or the involuntary motion of the diaphragm are the main causes of the lung motion occurring even under a breath-hold during CT scans.

As a result, motion artifacts of various lung structures, such as lung parenchyma, pulmonary vessels, or airways, are often visible in routine CT images. These artifacts impose challenges in the diagnosis of the lung using CT since they mimic various lung diseases, including bronchiectasis due to doubling edges, cysts, emphysema, or ground glass opacity (GGO) nodules because of CT-value bias. In addition, motion artifacts are one of the main challenges in quantitative chest CT. Thus, motion estimation in cardiac CT images is crucial for the evaluation of human heart anatomy and function.

Conventional CT image reconstruction methods generally assume that an object is stationary during data acquisition. Artifacts can severely affect a diagnosis that uses these reconstructed images, especially if the imaged features are small. Correction methods are required to detect motion artifacts and correct them in the reconstruction of images. For example, plaque formed in coronary arteries are generally indicative of a risk of a potential heart attack but are difficult to image due to their small size.

Developing efficient correction methods can be challenging due to the difficulties of accurately modelling the forward model and solving a complicated inverse problem. While motion correction of the coronary vessels requires a local motion model, global motion models are sufficient for organs, such as, for example, the lung or the skull.

Although many innovative technologies have been developed during the past decades to improve CT image quality, such as model-based iterative image reconstruction for breathing-motion correction or lung-motion correction, conventional imaging techniques employ brute force approaches to mitigate the effects of motion artifacts in CT imaging. Some of these techniques include employing two X-ray tubes or detector pairs angularly offset from each other, a heavier or higher power tube combined with spinning a gantry faster or combining data from successive heart cycles. These techniques and methods, however, are often time consuming, with a number of computational challenges and require expensive hardware. Particularly, for some challenging scenarios, the image quality is still inferior.

Accordingly, there exists a need to develop an efficient method for motion estimation and for the generation of motion artifact-free CT images using motion compensation reconstruction techniques. Additionally, improved methods are desired in order to reduce computational time, hardware costs, and to further improve CT image quality. The embodiments disclosed herein meet such a need.

### SUMMARY

In one embodiment, there is provided a medical image processing method includes obtaining a set of projection data acquired in a computed tomography (CT) scan of a three-dimensional region of an object to be examined; generating for each time point of a plurality of time points of the CT scan based on a part of the obtained set of projection data corresponding to the time point, a pair of feature maps for estimating motion at the time point so as to generate a plurality of pairs of feature maps, each feature map representing a feature of an image reconstructed from the part of the obtained set of projection data; estimating, based on the generated plurality of pairs of feature maps, a four-dimensional motion field, wherein the four-dimensional motion field indicates change of a motion of the object in the three-dimensional region over time; and reconstructing, based on the estimated four-dimensional motion field and the obtained set of projection data, a CT image of the object.

In another embodiment, there is provided A medical image processing apparatus, comprising processing circuitry configured to obtain a set of projection data acquired in a computed tomography (CT) scan of a three-dimensional region of an object to be examined; generate for each time point of a plurality of time points of the CT scan based on a part of the obtained set of projection data corresponding to the time point, a pair of feature maps for estimating motion at the time point so as to generate a plurality of pairs of feature maps, each feature map representing a feature of an image reconstructed from the part of the obtained set of projection data; estimate, based on the generated plurality of pairs of feature maps, a four-dimensional motion field, wherein the four-dimensional motion field indicates change of a motion of the object in the three-dimensional region over time; and reconstruct, based on the estimated four-dimensional motion field and the obtained set of projection data, a CT image of the object.

### BRIEF DESCRIPTION OF THE DRAWINGS

A more complete understanding of this disclosure is provided by reference to the following detailed description when considered in connection with the accompanying drawings, wherein:

FIG. 1 shows an example of a flow diagram of a method for motion estimation using scanned data and motion compensated image reconstruction, according to one implementation;

FIG. 2A shows an example of a flow diagram of a method for feature map reconstruction, according to one implementation;

FIG. 2B shows selection of a first set of projection data ranges for feature map reconstruction, according to one implementation;

FIG. 2C shows selection of a second set of projection data ranges for feature map reconstruction, according to one implementation;

FIG. 3 shows an example of a flow diagram of a method of 4D motion estimation using 3D non-rigid image registration, according to one implementation;

FIG. 4 shows an example of a flow diagram of a method of 4D motion estimation using a 3D deep convolutional neural network and a method for training the 3D deep convolutional neural network, according to one implementation;

FIG. 5 shows an example of a flow diagram of a method of 4D motion estimation using a 4D deep convolutional neural network and a method for training the 4D deep convolutional neural network, according to one implementation;

FIG. 6A shows an example of a DL network that is a feedforward artificial neural network (ANN), according to one implementation;

FIG. 6B shows an example of a DL network that is a convolutional neural network (CNN), according to one implementation;

FIG. 6C shows an example of implementing a convolution layer for one neuronal node of the convolution layer, according to one implementation;

FIG. 6D shows an example of a implementing a three-channel volumetric convolution layer for volumetric image data, according to one implementation; and

FIG. 7 shows a schematic of an implementation of a computed tomography (CT) scanner, according to one implementation.

### DETAILED DESCRIPTION

To address the above-identified challenges of known reconstruction methods for medical images, the methods described herein have been developed in order to estimate motion and perform reconstruction to generate motion-artifact-free images, and further improve image quality of medical images, such as lung and cardiac computed tomography (CT) images. Further, the examples provided herein of applying these methods are non-limiting, and the methods described herein can be applied to other medical imaging modalities, such as, MRI, PET/SPECT, etc., by adapting the framework described herein.

Accordingly, the discussion herein discloses and describes merely exemplary implementations of the present disclosure. As will be understood by those skilled in the art, the present disclosure may be embodied in other specific forms without departing from the spirit or essential characteristics thereof. Accordingly, the present disclosure is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

As discussed above, the CT image quality can be degraded by many factors, such as, respiratory motion and cardiac motion and other non-ideal physical phenomenon. As a result, developing efficient correction methods can be challenging due to existing techniques often being time consuming with a number of computational challenges that require expensive hardware. Particularly, for some challenging scenarios, the resultant image quality is still inferior.

To address the above-identified challenges of known methods, the methods described herein, use feature map-based motion estimation and motion-compensated reconstruction. A feature map can present edge and high-frequency information of the scanned object instead of a conventional CT image. For example, in certain implementations, in the methods described herein, filters are utilized to obtain a feature map of the scanned image. The feature map is further utilized for generation of a motion field, which is eventually utilized for compensation of the motion in reconstruction and generation of motion artifact-free images. In particular, various implementations of the methods described herein provide several advantages over previous methods of image reconstruction.

In certain implementations of the methods described herein, the generation of the motion field is achieved through image registration. First, image registration is performed utilizing the feature map, and then the motion field is generated using the results of the image registration. Image registration, also known as image fusion or image matching, is the process of aligning two or more images based on image appearance. Medical image registration seeks to find an optimal spatial transformation that best aligns the underlying anatomical structures in the images. Medical image registration is used in many clinical applications such as image guidance, motion tracking, segmentation, dose accumulation, image reconstruction, etc.

In certain implementations of the methods described herein, the generation of a motion field is achieved through deep learning (DL) networks. In certain implementations, offline training of a DL network is performed, and the trained network is then embedded in the reconstruction step. In general, DL networks have been adapted to image processing for improving image spatial resolution and reducing noise. As compared to traditional methods, deep learning does not require accurate modelling, relying instead on learning from training data sets. Therefore, the methods described herein can achieve better image quality in terms of motion artifact-free images than previous methods.

For example, the methods disclosed herein leverage improvements in various research areas whereby DL-based convolutional neural networks (CNN) can be used to generate motion-artifact-free reconstructed CT images. Training data corresponding to different CT scanning methods and scanning conditions can be used to train various CNN networks to be tailored for projection data corresponding to particular CT scanning methods, protocols, applications, and conditions by using training data selected to match the particular CT scanning methods, protocols, applications, and conditions. Thus, respective CNN networks can be customized and tailored to certain conditions and methods for CT scanning.

Additionally, the customization of CNN networks can extend to the motion field of the projection data and can be extended to the anatomical structure or region of the body being imaged. The methods described herein can be applied to motion estimation and compensation of reconstructed CT images. Further, the redundancy of information in adjacent slices of a three-dimensional CT image can be used to perform volumetric-based DL by using a kernel for the convolution layers of the DL network that extends to pixels in slices above and below a slice that is being denoised. In general, DL can be adapted to image processing for estimation of motion and generation of motion-free images.

Accordingly, feature maps, image registration, and convolution neural networks are used in the embodiments herein to obtain a motion field of the scanned image. The motion field is further utilized for motion compensation in the scanned image resulting in a high-quality motion-free scanned CT image.

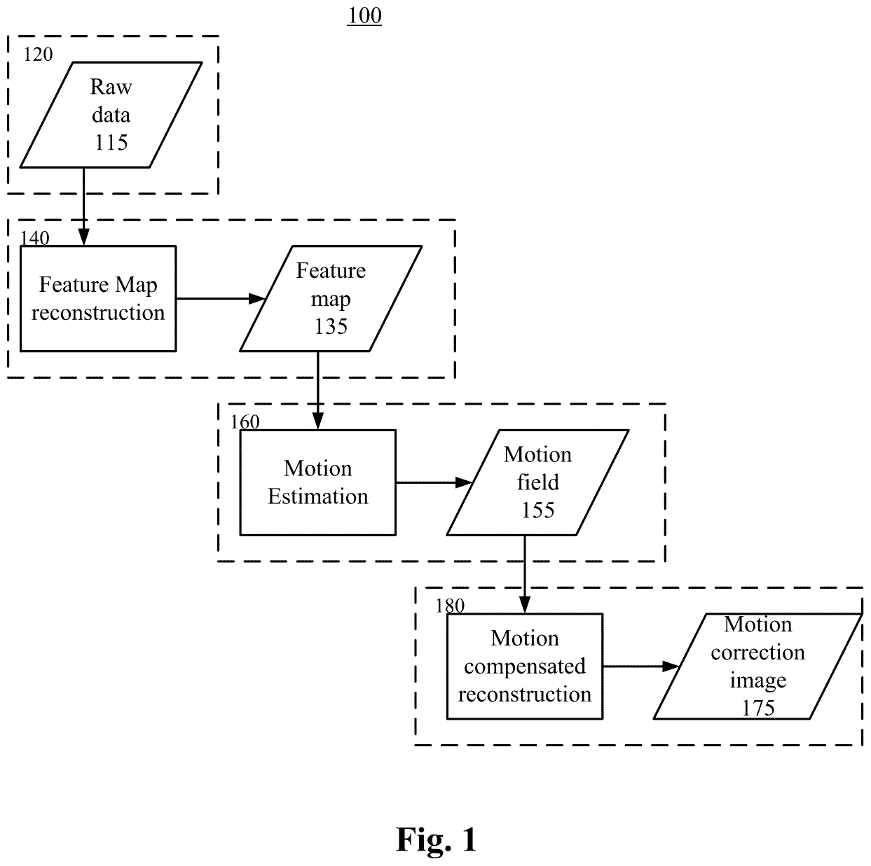

Referring now to the drawings, wherein like reference numerals designate identical or corresponding parts throughout the several views, FIG. 1 shows a flow diagram of a method 100. In the embodiments disclosed herein, method 100 is a method for motion estimation using scanned data and motion compensated image reconstruction.

In step 120, raw projection data 115 is obtained from a projection view. More generally, data 115 can be image data, which is obtained from a computed tomography (CT) apparatus through the process of back projection. Back projection is the process of mapping the raw projection data to an image. Generally, the projection data in several cycles is combined to reconstruct the final image. In the embodiments disclosed herein, partial raw projected data is obtained in step 120 for further processing.

In step 140, feature map reconstruction is performed using the raw data 115 to generate a feature map 135 of the scanned object. A feature map can represent, for example, edge and high frequency information of the scanned object. Feature maps include information in an image that can usually be viewed as a set of connected regions consisting of a collection of regions, each with basic features such as edges, frequency components related to some special image pattern, image intensity/color, prior shape, and texture. The aim of feature map reconstruction is to divide an image into specific regions that are adjacent to each other and do not overlap with each other according to different features of the image, and to divide these specific regions into different classes, with regions with the same or similar features grouped into the same class and different basic features between classes. In the embodiments disclosed herein, feature map generation is used to achieve an understanding of any object motion that occurred during scanning.

In the embodiments disclosed herein, the feature map reconstruction utilizes feature-enhancement filters and information about known parameters of the object being scanned, for example, such as, parameters of a heart when the scanned object is the heart of a patient. For example, feature enhancement filters, such as, for example, high-pass filters, low-pass filters, and bandpass filters are used. In an example of the embodiments disclosed herein, various segmentation methods can be used for feature map reconstruction, including traditional segmentation and DL-based segmentation methods. Histogram-based image value conversion can also be utilized to enhance features, and either enlarge the difference in value between organs and tissues in an image or reduce the differences between some special tissues and organs. Generally, feature-enhancement filters are used for highlighting certain information, for example, the features in the image, as well as weakening or removing any unnecessary information, such as, noise based on the known parameters of the scanned object. The highlighted information is presented as a feature map of the scanned object.

In step 160, the feature map 135 is used and a motion estimation is performed to obtain a motion field 155 of the scanned object. A motion field provides a detailed analysis of all the motion detected in the scanned image. The motion field can be a collection of the position of all features of a scanned image at all time points of a scan. This information is used to determine information about any change in position in a three-dimensional region at each increment of time, i.e., an indication of motion in the scanned data.

In step 180, the motion field 155 at the output of step 160 is used to perform motion-compensated reconstruction. Information from motion field 155 is used in the motion-compensated reconstruction to obtain motion correction image 175. The motion correction image 175 in the embodiments disclosed herein utilizes information from motion field 155, and removes corresponding motion artifacts to produce a motion-artifact-free image.

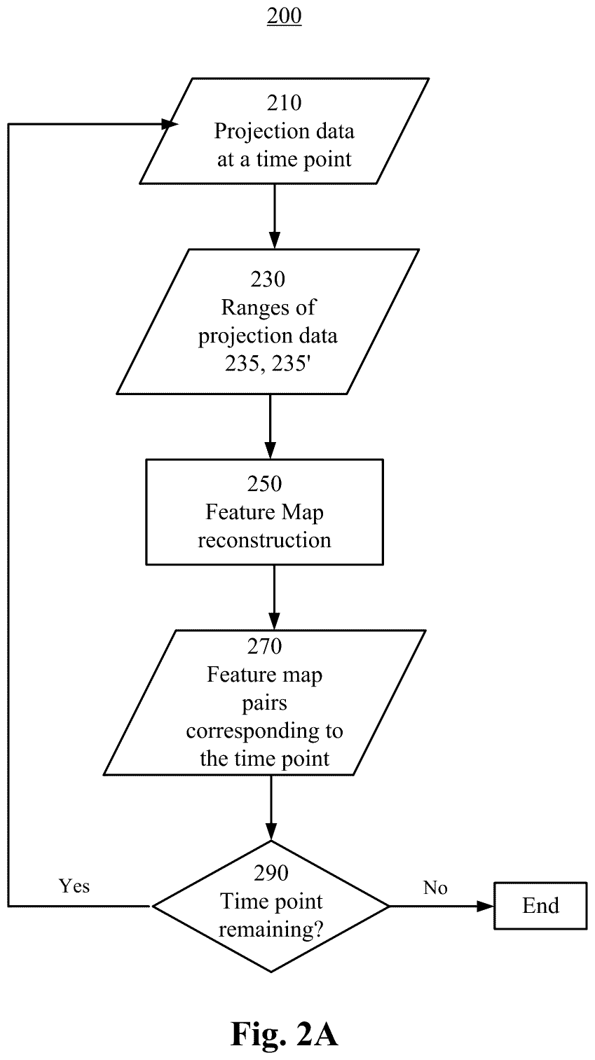

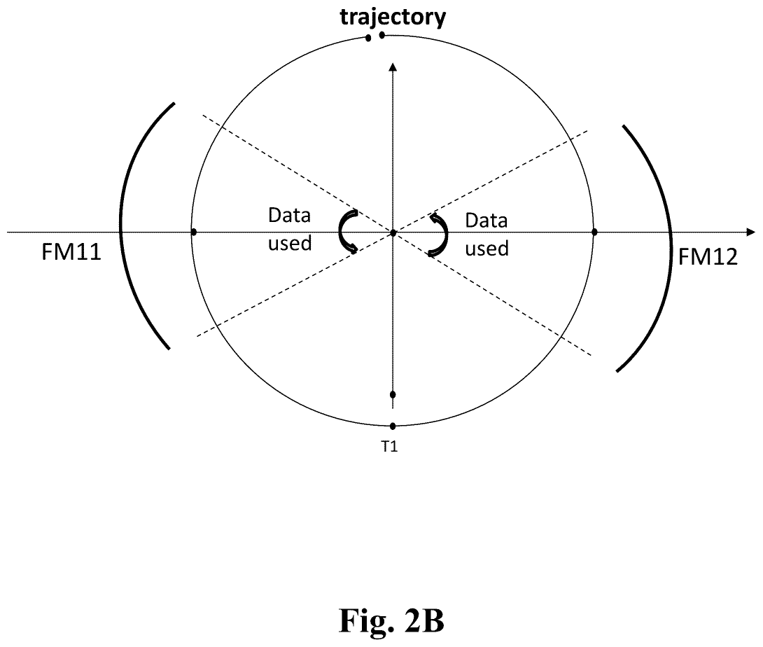

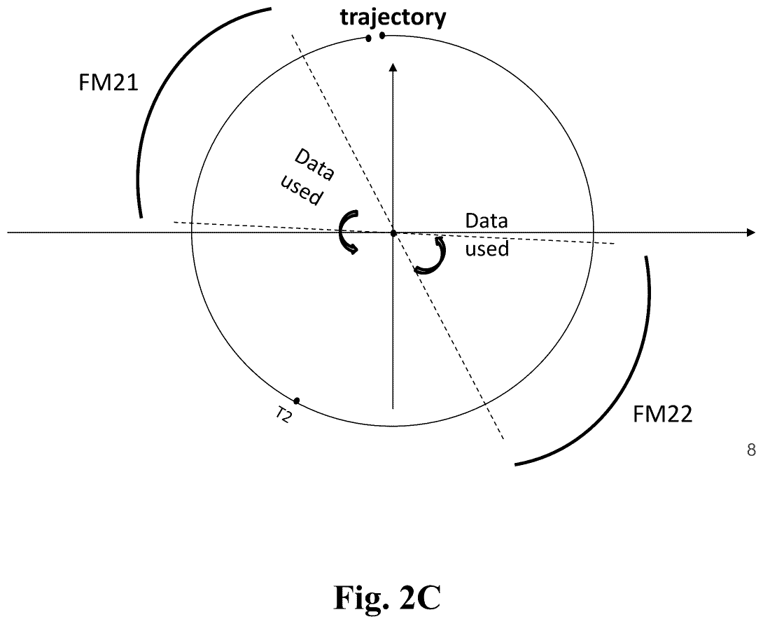

FIGS. 2A, 2B, and 2C show an implementation of the feature map reconstruction. FIG. 2A is a flow diagram of a method 200. In step 210 of method 200, a time point, for example, T1 is selected. The projection view presents data of the object being scanned and is obtained from a scan of the object. For example, the projection views are obtained from the detector of the CT apparatus. The projection view comprises raw data of the scanned object and represents a trajectory of one cycle of scanning, as shown in FIG. 2B. In step 210 of method 200, the projection view at time T1 of the trajectory is obtained.

In step 230, two data ranges corresponding to projection views on opposite sides of time point T1 on the trajectory are selected, as shown in FIG. 2B. These data ranges are the same, but on opposite sides. In the example implementation, shown in FIG. 2B, time ranges of each of the selected data ranges 235 and 235′ correspond to an angle of 90 degrees from the time point T1 selected in step 210 of process 200, but the data range can vary, for example, based on the speed of scanning an object, and the size and position of the target feature of the scanning object.

In step 250, feature map reconstruction is performed by extracting features from the projection data corresponding to ranges 235 and 235′. Conventionally, complete image reconstruction is performed from the data ranges of the projection view of the scanned object. In the implementation of the embodiments disclosed herein, only partial reconstruction is performed to obtain the feature map. Step 250 can be implemented in either of the two ways disclosed herein. In a first implementation of the example embodiments, projection-based feature extraction is performed.

In the first implementation of step 250, features from the raw projection data of the selected two data ranges is extracted and enhanced, and a feature map is generated. To perform such enhancement, a feature-enhancement filter is used. Generally, a high-pass filter or a band-pass filter can be used for feature enhancement. In certain example embodiments, a nonlinear transform can also be used to perform the enhancement. In one example, the feature extraction and enhancement are performed by implementing a deep neural network.

In this example, a feature map is generated using the extracted features using any of the various methods described above. Back-projected feature enhanced projection data can also be used to generate a feature map of the scanned object. For the selected two data ranges of the projection data, two feature maps are generated. A feature map pair comprising the two feature maps, for example FM11 and FM12, is generated. The feature map pair for the first two data ranges can be, for example, of high temporal resolution, due to the use of short data ranges.

In a second implementation of step 250, image-based feature extraction is performed. For such an implementation, back-projected projection data corresponding to the two selected data ranges is used to obtain a partial reconstruction image pair, say P11 and P12. Next, the partial reconstruction image pair P11 and P12 are used to generate feature map pair, FM11 and FM12. As described above, each of the feature map pairs FM11 and FM12 are generated by using feature enhancement filters, for example, such as high-pass filters or band-pass filters, a nonlinear transformation, or a feature extraction deep neural network.

Next steps 210 and 250 can be repeated for additional time points of the trajectory, for example, a new time point T2 is selected on the trajectory, as shown in FIG. 2C. Step 250 is repeated for time point T2 to obtain a corresponding feature map pair, for example, FM21 and FM22.

The generated feature map pairs are used to generate a motion field. The computation of accurate motion fields is a crucial aspect in 4D medical imaging as a motion field can affect changes in the image intensities over time. In the embodiments disclosed herein, the feature maps are generated to produce a 4D motion field of the scanned object.

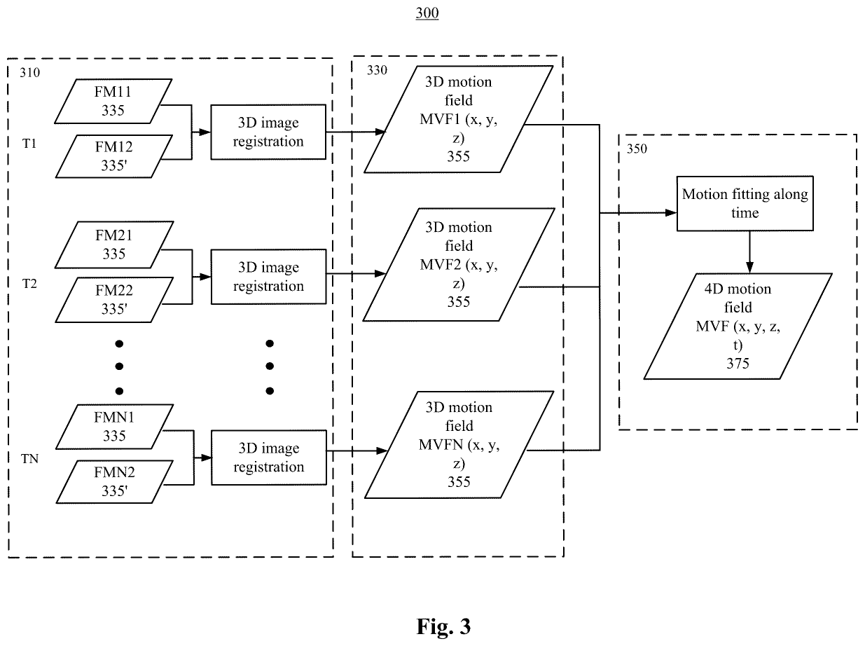

In a first embodiment of a 4D motion estimation, a first step towards generation of a 4D motion field is 3D image registration. FIG. 3 presents a method 300 of generating a 4D motion field from the feature map pairs using 3D image registration.

In step 310, a 3D image registration, e.g., traditional non-rigid image registration, is performed. In order to perform this step, each of the feature map pairs 335, 335′ obtained from step 250, corresponding to all time points on the trajectory of the scan are utilized as inputs. In one implementation, the 3D image registration generates a 3D object shape using the feature map pairs at each time point.

In the embodiments described above, results of each of 3D image registration, e.g., the output of step 310 is further used in step 330 to generate a 3D motion field 355 at each time point, for example, MVF1(x, y, z) corresponding to feature map pair FM11 and FM12 at time point T1, MVF2(x, y, z) corresponding to feature map pair FM21 and FM22 at time point T2, up to MVFN(x, y, z) corresponding to the nth feature map pair FMN1 and FMN2 at time point TN.

In step 350, the 3D motion fields 355 or (MVF1(x, y, z), MVF2(x, y, z), MVF3(x, y, z), . . . , MVFN(x, y, z)) are collated through motion fitting in time to obtain a 4D motion field MVF(x, y, z, t) 375. The 4D motion field 375 provides a detailed description of any motion of the scanned object.

In a second embodiment of 4D motion estimation, a 3D deep convolutional neural network (3D DCNN) is trained to output the 3D motion field based on input feature maps. Deep Convolutional Neural Networks (DCNN) are Deep Learning (DL) networks with a higher number of hidden layers, usually more than five, which are used to extract more features and increase the accuracy of the prediction. In general, DL can be adapted to image processing for improving image spatial resolution and reducing noise. As compared to traditional methods, DL does not require accurate noise and edge modelling and only relies on training data sets. Further, DL has the capability to capture the interlayer image features and build up a sophisticated network between noisy observations and latent clean images.

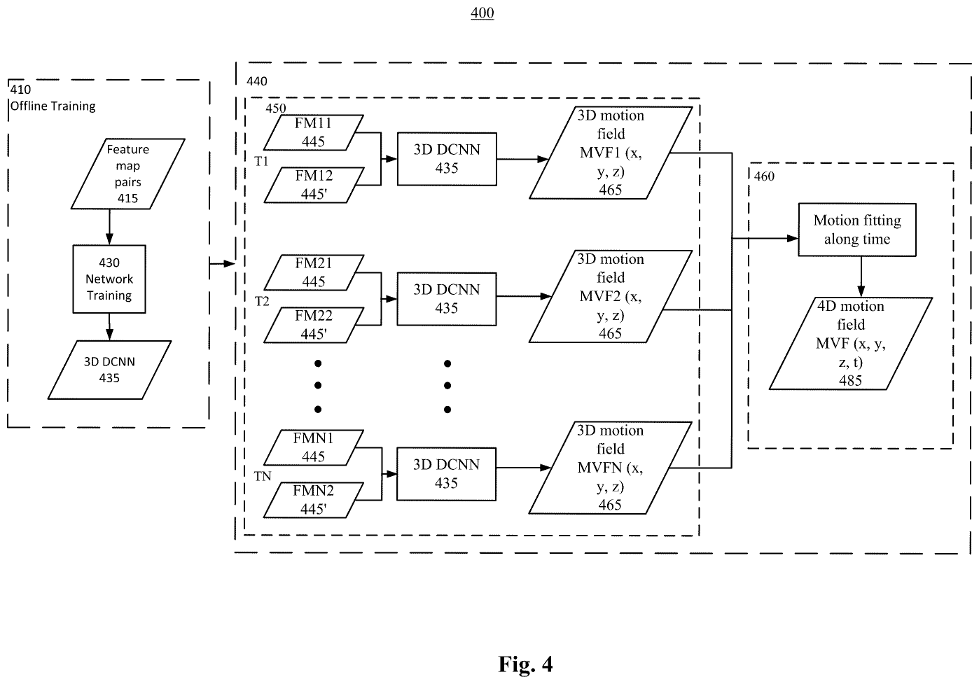

FIG. 4 is a flow diagram of method 400, which has two processes: process 410 for offline training of the 3D DCNN, and process 440 for generation of a 4D motion field from feature map pairs using the trained 3D DCNN.

The process 410 performs offline training of the 3D DL network 435, resulting in the 3D DL network being output in step 430. In one example, the offline 3D DL training process 410 trains the 3D DL network 435 using a large number of sets of 3D feature map pairs 415, for example, FM11 and FM12, generated, for example, in the process shown in FIG. 2A. The 3D DL network 435 essentially performs an image registration process. For example, the 3D DL network registers a set of feature map pairs 415, for example, pairs like FM11 and FM12, to obtain differences in the location of respective features between the pair, which is the motion.

In process 440, in step 450, each of the feature map pairs 445, 445′ utilizes the trained 3D DL network 435 to generate a corresponding 3D motion field at each time point, for example, MVF1(x, y, z) corresponding to feature map pair FM11 and FM12 at time point T1, MVF2(x, y, z) corresponding to feature map pair FM21 and FM22, at time point T2, up to MVFN(x, y, z) corresponding to the nth feature map pair FMN1 and FMN2, at time point TN. The 3D motion fields 465 at every time point corresponds to a position of each part of the scanned object, i.e., a feature in a three-dimensional region.

In step 460, the 3D motion fields 465 at each time point (MVF1(x, y, z), MVF2(x, y, z), MVF3(x, y, z), . . . , MVFN(x, y, z)) are collated through motion fitting in time to obtain a 4D motion field MVF(x, y, z, t) 485. The 4D motion field 485 provides a detailed description of any motion in the scanned object.

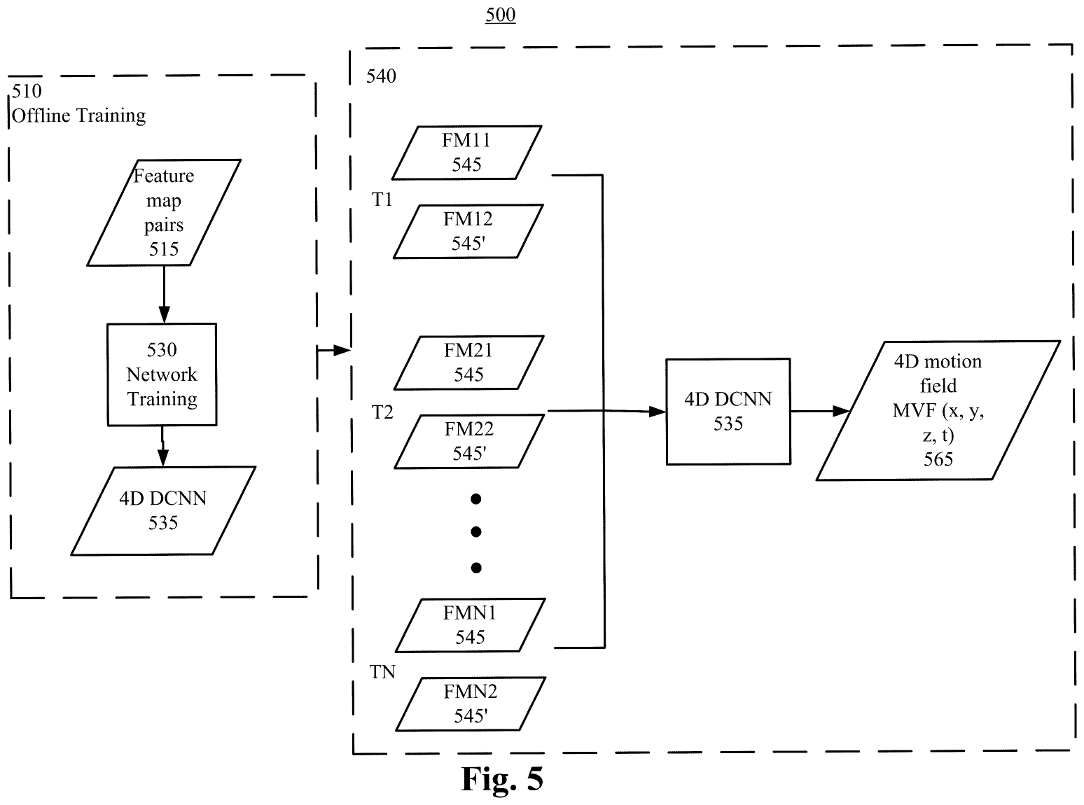

FIG. 5 shows an alternate implementation of 4D motion field estimation. In method 500, there are two processes: process 510 for offline training of a 4D DCNN, and process 540 for generation of a 4D motion field from feature map pairs using the 4D DCNN.

The process 510 of method 500 performs 4D offline training of the 4D DL network 535. In step 530, a set of feature map pairs 515, such as, for example FM11 and FM12, are used as training data to train a 4D DL network 535, similar to training the 3D DL network 435. The training results in the 4D DL network output from step 530.

In process 540, each of the feature map pairs 545, 545′ utilizes the trained 4D DL network 535 to generate a 4D motion field, 4D MVF(x, y, z, t) 565. The 4D motion field 565 provides a detailed description of any motion of the scanned object.

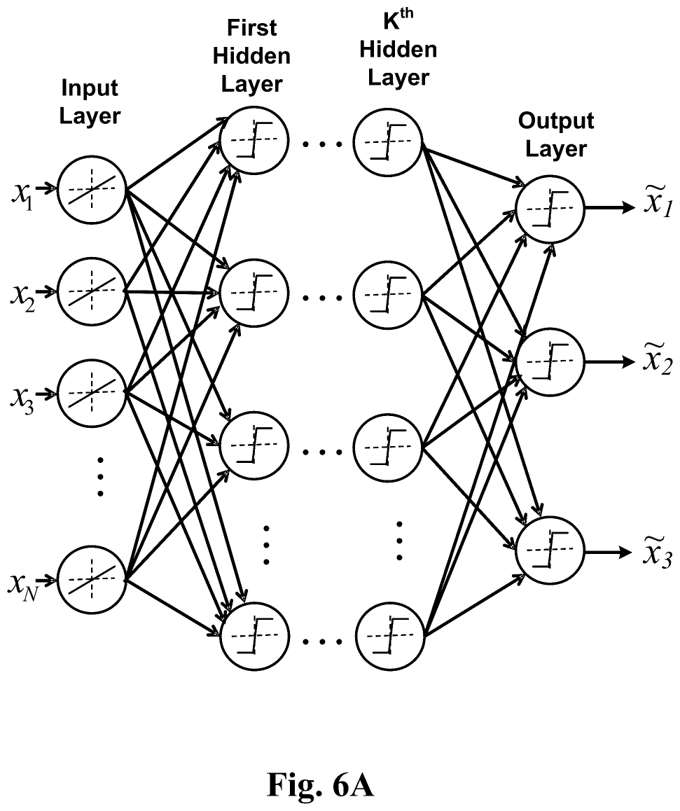

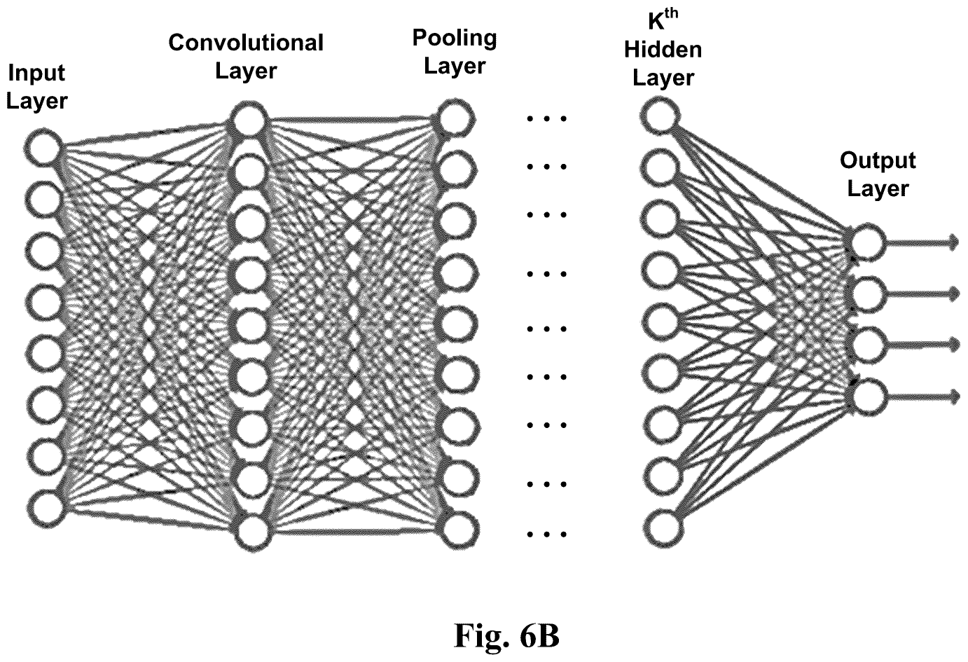

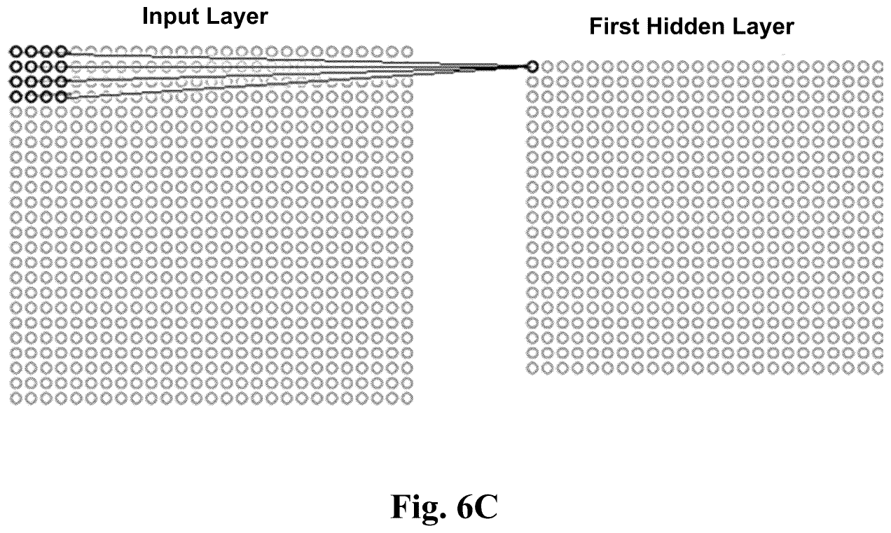

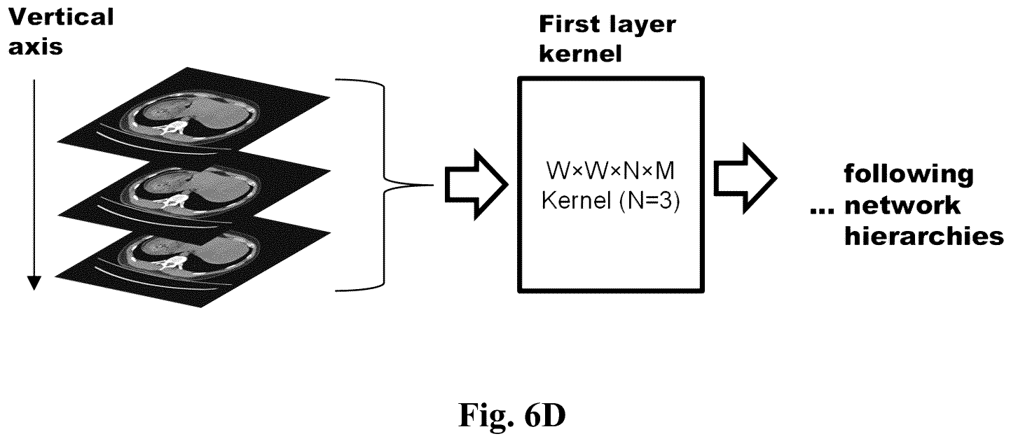

FIGS. 6A, 6B, 6C, and 6D show various examples of the 3D DL network 435 or the 4D DL network 535.

FIG. 6A shows an example of a general artificial neural network (ANN) having N inputs, K hidden layers, and three outputs. Each layer is made up of nodes (also called neurons), and each node performs a weighted sum of the inputs and compares the result of the weighted sum to a threshold to generate an output. ANNs make up a class of functions for which the members of the class are obtained by varying thresholds, connection weights, or specifics of the architecture such as the number of nodes and/or their connectivity. The nodes in an ANN can be referred to as neurons (or as neuronal nodes), and the neurons can have interconnections between the different layers of the ANN system. The simplest ANN has three layers, and is called an autoencoder. The 3D DL network 435 or the 4D DL network 535 generally has more than three layers of neurons, and has as many outputs neurons as input neurons, wherein N is the number of pixels in the motion field. The synapses (i.e., the connections between neurons) store values called “weights” (also interchangeably referred to as “coefficients” or “weighting coefficients”) that manipulate the data in the calculations. The outputs of the ANN depend on three types of parameters: (i) the interconnection pattern between the different layers of neurons, (ii) the learning process for updating the weights of the interconnections, and (iii) the activation function that converts a neuron's weighted input to its output activation.

Mathematically, a neuron's network function is defined as a composition of other functions, which can further be defined as a composition of other functions. This can be conveniently represented as a network structure, with arrows depicting the dependencies between variables, as shown in FIG. 6. For example, the ANN can use a nonlinear weighted sum, wherein, where K (commonly referred to as the activation function) is some predefined function, such as the hyperbolic tangent.

In FIG. 6A (and similarly in FIG. 6B), the neurons (i.e., nodes) are depicted by circles around a threshold function. For the non-limiting example shown in FIG. 6A, the inputs are depicted as circles around a linear function, and the arrows indicate directed connections between neurons. In certain implementations, the 3D DL network 435 or the 4D DL network 535 is a feedforward network as exemplified in FIGS. 6A and 6B (e.g., it can be represented as a directed acyclic graph).

The 3D DL network 435 or the 4D DL network 535 operates to achieve a specific task, such as motion artifact estimation of a CT image, denoising a CT image, by searching within the class of functions F to learn, using a set of observations, to find which solves the specific task in some optimal sense For example, in certain implementations, this can be achieved by defining a cost function such that, for the optimal solution, (i.e., no solution has a cost less than the cost of the optimal solution). The cost function C is a measure of how far away a particular solution is from an optimal solution to the problem to be solved (e.g., the error). Learning algorithms iteratively search through the solution space to find a function that has the smallest possible cost. In certain implementations, the cost is minimized over a sample of the data (i.e., the training data).

FIG. 6B shows a non-limiting example in which the 3D DL network 435 or the 4D DL network 535 is a convolutional neural network (CNN). CNNs are type of ANN that has beneficial properties for image processing, and, therefore, have specially relevancy for the applications of motion estimation. CNNs use feed forward ANNs in which the connectivity pattern between neurons can represent convolutions in image processing. For example, CNNs can be n used for image-processing optimization by using multiple layers of small neuron collections which process portions of the input image, called receptive fields. The outputs of these collections can then tile so that they overlap, to obtain a better representation of the original image. This processing pattern can be repeated over multiple layers having alternating convolution and pooling layers.

FIG. 6C shows an example of a 4×4 kernel being applied to map values from an input layer representing a two-dimensional image to a first hidden layer, which is a convolution layer. The kernel maps respective 4×4 pixel regions to corresponding neurons of the first hidden layer.

Following after a convolutional layer, a CNN can include local and/or global pooling layers, which combine the outputs of neuron clusters in the convolution layers. Additionally, in certain implementations, the CNN can also include various combinations of convolutional and fully connected layers, with pointwise nonlinearity applied at the end of or after each layer.

CNNs have several advantages for image processing. To reduce the number of free parameters and improve generalization, a convolution operation on small regions of input is introduced. One significant advantage of certain implementations of CNNs is the use of shared weight in convolutional layers, which means that the same filter (weights bank) is used as the coefficients for each pixel in the layer; this both reduces memory footprint and improves performance. Compared to other image-processing methods, CNNs advantageously use relatively little pre-processing. This means that the network is responsible for learning the filters that in traditional algorithms were hand-engineered. The lack of dependence on prior knowledge and human effort in designing features is a major advantage for CNNs.

FIG. 6D shows an implementation of 3D DL network 435 that takes advantage of the similarities between adjacent layers in reconstructed three-dimensional medical. The signal in adjacent layers is ordinarily highly correlated, whereas the noise is not. That is, in general, a three-dimensional volumetric image in CT usually can provide more diagnostic information than single slice transverse two-dimensional image since more volumetric features can be captured. Based in this insight, certain implementations of the methods described herein use a volumetric-based deep-learning algorithm to improve the CT images. This insight and corresponding method also apply to other medical imaging areas such as MRI, PET, etc.

As shown in FIG. 6D, a slice and the adjacent slices (i.e., the slice above and below the central slice) are identified as a three-channel input for the network. To these three layers, a W×W×3 kernel is applied M times to generate M values for the convolutional layer, which are then used for the following network layers/hierarchies (e.g., a pooling layer). This W×W×3 kernel can also be thought of and implemented as three W×W kernels respectively applied as three-channel kernels that are applied to the three slices of volumetric image data, and the result is an output for the central layer, which is used as an input for the following network hierarchies. The value M is the total filter number for a given slice of the convolutional layer, and W is the kernel size (e.g., W=4 in FIG. 6C).

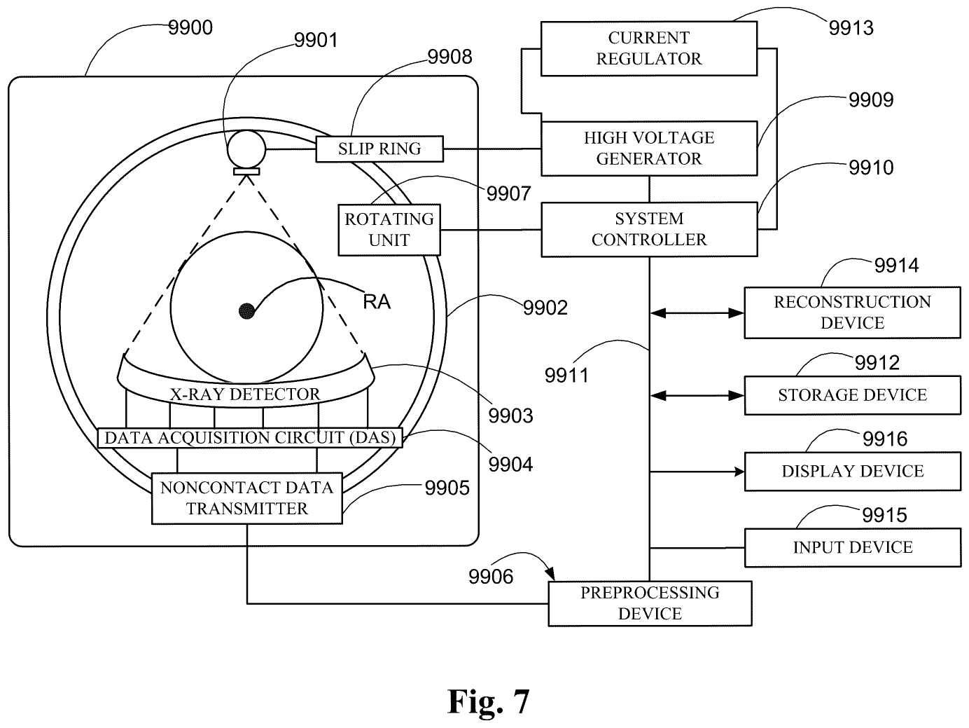

It can be appreciated that, in one embodiment, the implementations described above, of motion estimation and compensation is applicable to a computed tomography (CT) apparatus or scanner. FIG. 7 illustrates an implementation of a radiography gantry included in a CT apparatus or scanner. As shown in FIG. 7, a radiography gantry 9900 is illustrated from a side view and further includes an X-ray tube 9901, an annular frame 9902, and a multi-row or two-dimensional-array-type X-ray detector 9903. The X-ray tube 9901 and X-ray detector 9903 are diametrically mounted across an object, such as, for example, a patient, on the annular frame 9902, which is rotatably supported around a rotation axis RA. A rotating unit 9907 rotates the annular frame 9902 at a high speed, such as, for example, 0.4 sec/rotation, while the object is being moved along the axis RA into or out of the illustrated page.

An embodiment of an X-ray computed tomography (CT) apparatus according to the present disclosure will be described below with reference to the views of the accompanying drawing. Note that X-ray CT apparatuses include various types of apparatuses, e.g., a rotate/rotate-type apparatus in which an X-ray tube and X-ray detector rotate together around an object to be examined, and a stationary/rotate-type apparatus in which many detection elements are arrayed in the form of a ring or plane, and only an X-ray tube rotates around an object to be examined. The present disclosure can be applied to either type. In this case, the rotate/rotate type, which is currently the mainstream, will be exemplified.

The multi-slice X-ray CT apparatus further includes a high voltage generator 9909 that generates a tube voltage applied to the X-ray tube 9901 through a slip ring 9908 such that the X-ray tube 9901 generates X-rays. An X-ray detector 9903 is located at an opposite side from the X-ray tube 9901 across the object for detecting the emitted X-rays that have transmitted through the object. The X-ray detector 9903 is for example a photon-counting detector. The X-ray detector, or the photon-counting detector 9903 further includes individual detector elements or units, such as, for example, a processing circuitry.

The CT apparatus further includes other devices for processing the detected signals from X-ray detector 9903. A data acquisition circuit or a Data Acquisition System (DAS) 9904 converts a signal output from the X-ray detector 9903 for each channel into a voltage signal, amplifies the signal, and further converts the signal into a digital signal. The X-ray detector 9903 and the DAS 9904 are configured to manage a predetermined total number of projections per rotation (TPPR).

The above-described data is sent to a preprocessing device 9906, which is housed in a console outside the radiography gantry 9900 through a non-contact data transmitter 9905. The preprocessing device 9906 performs certain corrections, such as sensitivity correction on the raw data or the various implementations of the motion estimation and compensation in CT scan images.

In an embodiment, the pre-processing device 9906 implements the various implementations of the motion estimation and compensation in CT scan images, as described in embodiments above. A memory 9912 stores the resultant data, which is also called projection data at a stage immediately before reconstruction processing. The memory 9912 is connected to a system controller 9910 through a data/control bus 9911, together with a reconstruction device 9914, input device 9915, and display 9916. The system controller 9910 controls a current regulator 9913 that limits the current to a level sufficient for driving the CT system.

The detectors are rotated and/or fixed with respect to the object being scanned, such as the patient, among various generations of the CT scanner systems. In one implementation, the above-described CT system can be an example of a combined third-generation geometry and fourth-generation geometry system. In the third-generation system, the X-ray tube 9901 and the X-ray detector 9903 are diametrically mounted on the annular frame 9902 and are rotated around the object as the annular frame 9902 is rotated about the rotation axis RA. In the fourth-generation geometry system, the detectors are fixedly placed around the patient and an X-ray tube 9901 rotates around the patient. In an alternative embodiment, the radiography gantry 9900 has multiple detectors arranged on the annular frame 9902, which is supported by a C-arm and a stand.

The memory 9912 can store the measurement value representative of the irradiance of the X-rays at the X-ray detector unit 9903. Further, the memory 9912 can store a dedicated program for executing various steps of the methods for motion estimation and compensation in CT scan images, such as example method 100,

Post-reconstruction processing performed by the reconstruction device 9914 can include filtering and smoothing the image, volume rendering processing, and image difference processing as needed. The image reconstruction process can implement various CT image reconstruction methods. The reconstruction device 9914 can use the memory to store, e.g., projection data, reconstructed images, calibration data and parameters, and computer programs.

Further, the memory 9912 can be non-volatile, such as ROM, EPROM, EEPROM or FLASH memory. The memory 9912 can also be volatile, such as static or dynamic RAM, and a processor, such as a microcontroller or microprocessor, can be provided to manage the electronic memory as well as the interaction between the FPGA or CPLD and the memory.

In one implementation, the reconstructed images can be displayed on a display 9916. The display 9916 can be an LCD display, CRT display, plasma display, OLED, LED, or any other display known in the art. The memory 9912 can be a hard disk drive, CD-ROM drive, DVD drive, FLASH drive, RAM, ROM, or any other electronic storage known in the art.

While certain implementations have been described, these implementations have been presented by way of example only, and are not intended to limit the teachings of this disclosure. Indeed, the novel methods, apparatuses and systems described herein may be embodied in a variety of other forms; furthermore, various omissions, substitutions, and changes in the form of the methods, apparatuses and systems described herein may be made without departing from the spirit of this disclosure.

1. A medical image processing method, comprising:
obtaining a set of projection data acquired in a computed tomography (CT) scan of a three-dimensional region of an object to be examined;
generating for each time point of a plurality of time points of the CT scan based on a part of the obtained set of projection data corresponding to the time point, a pair of feature maps for estimating motion at the time point so as to generate a plurality of pairs of feature maps, each feature map representing a feature of an image reconstructed from the part of the obtained set of projection data;
estimating, based on the generated plurality of pairs of feature maps, a four-dimensional motion field, wherein the four-dimensional motion field indicates change of a motion of the object in the three-dimensional region over time; and
reconstructing, based on the estimated four-dimensional motion field and the obtained set of projection data, a CT image of the object.

2. The medical image processing method of claim 1, wherein the generating step further comprises:
applying feature extraction processing to at least the part of the obtained set of projection data to obtain feature data; and
reconstructing the plurality of pairs of feature maps based on the obtained feature data.

3. The medical image processing method of claim 2, wherein the feature extraction processing comprises utilizing a feature-enhancement filter, utilizing a nonlinear transform, or utilizing a feature-extraction machine-learning model.

4. The medical image processing method of claim 1, wherein the generating step further comprises:
reconstructing a plurality of partial angle reconstruction (PAR) images based on the part of the obtained set of projection data; and
applying feature extraction processing on the plurality of PAR images to obtain the plurality of pairs of feature maps.

5. The medical image processing method of claim 1, wherein the estimating step further comprises:
performing, for each pair of the plurality of pairs of feature maps, registration processing between the feature maps of the pair to generate a plurality of three-dimensional motion fields, one at each time point of the plurality of time points; and
fitting the generated plurality of the three-dimensional motion fields to obtain the four-dimensional motion field.

6. The medical image processing method of claim 1, wherein the step of estimating further comprises:
applying, to a trained machine-learning model for motion estimation, each pair of the plurality of pairs of the feature maps to generate a plurality of three-dimensional motion fields, one at each time point of the plurality of time points; and
fitting the generated plurality of the three-dimensional motion fields to obtain the four-dimensional motion field.

7. The medical image processing method of claim 6, wherein the trained machine-learning model for motion estimation is a 3D deep convolutional neural network.

8. The medical image processing method of claim 6, wherein the step of applying the trained machine-learning model for motion estimation further comprising:
training a neural network using training data and a function that represents a disagreement between pairs of data as an error value, the training data including pairs in which a pair includes defect-exhibiting data paired with corresponding defect-minimized data, and the neural network including is trained by performing, for each of the pairs, the steps of
applying the neural network to defect-exhibiting data of a pair to generate network processed data;
calculating, using the function, the error value between the network processed data and the defect-minimized data of the pair;
updating, based on the calculated error value, the weighting coefficients of the neural network; and
repeating the steps of applying, calculating, and updating using respective pairs of the training data until one or more stopping criteria are satisfied.

9. The medical image processing method of claim 1, wherein the estimating step further comprises applying, to a trained machine-learning model for motion estimation, each one of the plurality of pairs of the feature maps to generate the four-dimensional motion field.

10. The medical image processing method of claim 9, wherein the trained machine-learning model for motion estimation is a 4D deep convolutional neural network.

11. The medical image processing method of claim 1, wherein the obtaining step further comprises obtaining the set of projection data using a computed tomography (CT) scanner apparatus.

12. The medical image processing method of claim 11, wherein the obtaining step comprises obtaining the set of projection data using a helical scan or a volume scan.

13. A medical image processing apparatus, comprising:
processing circuitry configured to
obtain a set of projection data acquired in a computed tomography (CT) scan of a three-dimensional region of an object to be examined;
generate for each time point of a plurality of time points of the CT scan based on a part of the obtained set of projection data corresponding to the time point, a pair of feature maps for estimating motion at the time point so as to generate a plurality of pairs of feature maps, each feature map representing a feature of an image reconstructed from the part of the obtained set of projection data;
estimate, based on the generated plurality of pairs of feature maps, a four-dimensional motion field, wherein the four-dimensional motion field indicates change of a motion of the object in the three-dimensional region over time; and
reconstruct, based on the estimated four-dimensional motion field and the obtained set of projection data, a CT image of the object.

14. The medical image processing apparatus of claim 13, wherein the processing circuitry is further configured to, in generating the pair of feature maps:
apply feature extraction processing to at least the part of the obtained set of projection data to obtain feature data; and
reconstruct the plurality of pairs of feature maps based on the obtained feature data.

15. The medical image processing apparatus of claim 14, wherein the feature extraction processing performed by the processing circuitry comprises utilizing a feature-enhancement filter, utilizing a nonlinear transform, or utilizing a feature-extraction machine-learning model.

16. The medical image processing apparatus of claim 13, wherein the processing circuitry is further configured to, in generating the pair of feature maps:
reconstruct a plurality of partial angle reconstruction (PAR) images based on the part of the obtained set of projection data; and
apply feature extraction processing on the plurality of PAR images to obtain the plurality of pairs of feature maps.

17. The medical image processing apparatus of claim 13, wherein the processing circuitry is further configured to, in estimating the four-dimensional motion field:
perform, for each pair of the plurality of pairs of feature maps, registration processing between the feature maps of the pair to generate a plurality of three-dimensional motion fields, one at each time point of the plurality of time points; and
fit the generated plurality of the three-dimensional motion fields to obtain the four-dimensional motion field.

18. The medical image processing apparatus of claim 13, wherein the processing circuitry is further configured to, in estimating the four-dimensional motion field:
apply, to a trained machine-learning model for motion estimation, each pair of the plurality of pairs of the feature maps to generate a plurality of three-dimensional motion fields, one at each time point of the plurality of time points; and
fit the generated plurality of the three-dimensional motion fields to obtain the four-dimensional motion field.

19. The medical image processing apparatus of claim 18, wherein the trained machine-learning model for motion estimation is a 3D deep convolutional neural network.

20. The medical image processing apparatus of claim 13, wherein the processing circuitry is further configured to, in estimating the four-dimensional motion field, apply, to a trained machine-learning model for motion estimation, each one of the plurality of pairs of the feature maps to generate the four-dimensional motion field.
